(19) United States
(12) Patent Application Publication
(10) Pub. No.: US 2014/0327647 A1
(43) Pub. Date: Nov. 6, 2014

(54) TOUCHSCREEN DEVICE, METHOD FOR SENSING TOUCH INPUT AND METHOD FOR GENERATING DRIVING SIGNAL

(71) Applicants: Amiya Ray, Suwon (KR); Hyun Suk Lee, Suwon (KR)

(72) Inventors: Amiya Ray, Suwon (KR); Hyun Suk Lee, Suwon (KR)

(73) Assignee: Samsung Electro-Mechanics Co., Ltd., Suwon (KR)

(21) Appl. No.: 14/212,555

(22) Filed: Mar. 14, 2014

(30) Foreign Application Priority Data
Dec. 30, 2012 (KR) 10-2013-0166925

(51) Int. Cl. G06F 3/044

(52) U.S. Cl. CPC G06F 3/044
USPC 345/174

(57) ABSTRACT

There are provided a touchscreen device, a method for sensing a touch input, and a method for generating driving signals. The touchscreen device includes: a panel unit including a plurality of first electrodes and a plurality of second electrodes; a driving circuit unit simultaneously applying driving signals to N first electrodes among the first electrodes, where N is a natural number equal to or greater than two; a sensing circuit unit detecting capacitance generated in intersections of the first electrodes and the second electrodes so as to output sensing signals; and an operation unit determining whether a touch has occurred based on the sensing signals.

### CROSS-REFERENCE TO RELATED APPLICATION

This application claims the benefit of Korean Patent Application No. 10-2013-0166925 filed on Dec. 30, 2013, with the Korean Intellectual Property Office, the disclosure of which is incorporated herein by reference.

### BACKGROUND

The present disclosure relates to a touchscreen device, a method for sensing a touch input, and a method for generating driving signals.

A touchscreen device, such as a touchscreen or a touch pad, is a data input device attached to a display device so as to provide an intuitive user interface, and has recently been widely applied to various electronic devices such as cellular phones, personal digital assistants (PDA), and navigation devices. Particularly, as demand for smartphones has been recently increased, touchscreens have been increasingly employed therein, since they are able to provide users with various data input methods in a limited form factor.

Touchscreens used in portable devices may be mainly divided into resistive type touchscreens and capacitive type touchscreens, depending on the manner in which touches are sensed therein. Among these, capacitive type touchscreens have advantages of a relatively long lifespan and ease in the implementation of various types of data input and gestures thereof, and thus it has been increasingly employed. It is especially easy to implement a multi-touch interfaces with capacitive type touchscreens, as compared to resistive type touchscreens, and thus, capacitive type touchscreens are widely used in smartphones and the like.

Capacitive type touchscreens include a plurality of electrodes having a predetermined pattern and the electrodes form a plurality of nodes in which changes in capacitance are generated due to touches. The nodes provided on a two-dimensional plane generate changes in self-capacitance or changes in mutual-capacitance due to touches. Coordinates of touches may be calculated by applying a weighted average calculation method or the like to changes in the capacitance occurring in the nodes.

Recently, touchscreen devices have commonly been employed in laptop computers, TVs and the like, having large screens, as well as small mobile devices. As the size of touchscreen devices has increased, the number and size of electrodes included therein have also increased. Accordingly, when driving signals are sequentially applied to a plurality of electrodes, driving times are increased in proportion to the number of electrodes, and capacitance is increased proportional to the size of the electrodes, so that voltage charging times, i.e., driving times, are increased.

### RELATED ART DOCUMENT

(Patent Document 1) Japanese Patent Laid-Open Publication No. 2013-149223

### SUMMARY

An aspect of the present disclosure may provide a touchscreen device, a method for sensing touches, and a method for generating driving signals capable of simultaneously applying driving signals to N driving electrodes of a plurality of driving electrodes, wherein the driving signals are generated according to a matrix in which an element in a first column of a first row is −1, elements in second to Nth columns of the first row are −1 s, elements in second to (1+((N−4)/2))th rows of the first column are −1 s, elements in (2+((N−4)/2))th to the Nth rows of the first column are 1 s, and elements in the second to Nth columns of the second to Nth rows are created according to a maximum length sequence.

According to an aspect of the present disclosure, a touchscreen device may include: a panel unit including a plurality of first electrodes and a plurality of second electrodes; a driving circuit unit simultaneously applying driving signals to N first electrodes among the first electrodes, where N is a natural number equal to or greater than two; a sensing circuit unit detecting capacitance generated in intersections of the first electrodes and the second electrodes so as to output sensing signals; and an operation unit determining whether a touch has occurred based on the sensing signals, wherein the driving circuit unit generates the driving signals according to a matrix of N by N, wherein an element in a first column of a first row is −1, elements in second to Nth columns of the first row are is, elements in second to (1+((N−4)/2))th rows of the first column are −1 s, elements in (2+((N−4)/2)) th to the Nth rows of the first column are 1 s, and elements in the second to Nth columns of the second to Nth rows are created according to a maximum length sequence.

Elements in the second to Nth columns of the second row of the matrix may be created by inverting codes according to the maximum length sequence, and elements in the second to Nth columns of the third to Nth rows of the matrix may be created by shifting elements in the second to Nth columns of the second row of the matrix by one bit for every row.

The driving circuit unit may simultaneously apply driving signals generated according to N rows of the matrix to the N first electrodes.

The driving circuit unit may apply driving signals generated according to N columns of the matrix at respective N timings.

The sensing circuit unit may detect capacitance and output the sensing signals using

Sk=Σₜ₌₁^{m}Ct,k*Dt

where Sk denotes a sensing signal, C_{t,k} denotes capacitance generated in intersections of first electrodes Xt and second electrodes Yk, and Dt denotes driving signal applied to first electrodes Xt.

The operation unit may determine whether a touch has occurred based on a correlation value during a single period calculated by performing a correlation operation between the sensing signals acquired during a single period of the driving signals and the matrix.

According to another aspect of the present disclosure, a method for sensing a touch input may include: applying driving signals to N first electrodes among a plurality of first electrodes, where N is a natural number equal to or greater than two; obtaining sensing signals from second electrodes intersecting the first electrodes; and determining whether a touch has occurred by calculating a correlation value between the sensing signals and the driving signals, wherein the applying of the driving signals includes applying the driving signals generated according to a matrix of N by N to the N first electrodes, wherein an element in a first column of a first row is −1, elements in second to Nth columns of the first row are is, elements in second to (1+((N−4)/2))th rows of the first column are −1 s, elements in (2+((N−4)/2))th to the Nth rows of the first column are is, and elements in the second to Nth columns of the second to Nth rows are created according to a maximum length sequence.

In the applying of the driving signals, elements in the second to Nth columns of the second row of the matrix may be created by inverting codes according to the maximum length sequence, and elements in the second to Nth columns of the third to Nth rows of the matrix may be created by shifting elements in the second to Nth columns of the second row of the matrix by one bit for every row.

The applying of the driving signals may include simultaneously applying driving signals generated according to N rows of the matrix to the N first electrodes.

The applying of the driving signals may include applying driving signals generated according to N columns of the matrix at respective N timings.

The determining whether a touch has occurred may include determining whether a touch has occurred based on a correlation value calculated by performing a correlation operation between the sensing signals acquired during a single period of the driving signals and the matrix.

According to another aspect of the present disclosure, a method for generating driving signals to be applied to a plurality of driving electrodes of a touchscreen device may include: creating a first matrix of (N−1) by (N−1) by determining elements in a first row according to a maximum length sequence and determining elements in the rest rows by shifting the elements in the first row by one bit, where N is a natural number equal to or greater than two; creating a second matrix of N by N by adding a first row and a first column having elements of all is to the first matrix; creating a third matrix by inverting an element in the first column of the first row of the second matrix and elements in the second to Nth columns of the second to Nth rows; creating a fourth matrix by inverting elements in the second to the (1+((N−4)/2))th rows of the first column of the third matrix; and generating driving signals according to the fourth matrix.

The generating of the driving signals may include generating positive driving signals for the elements indicated by 1 in the fourth matrix and negative driving signals for the elements indicated by −1 in the third matrix.

The generating of the driving signals may include generating the driving signals according to N rows of the fourth matrix, and the driving signals generated according to N rows of the fourth matrix are simultaneously applied to N driving electrodes of the plurality of driving electrodes.

The generating of the driving signals may include generating the driving signals according to N columns of the fourth matrix, and the driving signals generated according to N columns of the fourth matrix are applied to the plurality of driving electrodes at respective N timings.

The creating of the third matrix may include inverting elements in the second to Nth columns of the second to Nth rows of the second matrix and eliminating the first row to create the third matrix; and wherein the creating of the fourth matrix includes inverting elements in the first to (fix((T−1)/2)) rows of the first column of the third matrix to create the fourth matrix, where T denotes a length of the rows of the third matrix, and fix(x) denotes a function that drops the part to the right of the decimal point of x.

According to another aspect of the present disclosure, a touchscreen device may include: a panel unit including a plurality of first electrodes and a plurality of second electrodes; a driving circuit unit simultaneously applying driving signals to N first electrodes among the first electrodes, where N is a natural number equal to or greater than two; a sensing circuit unit detecting capacitance generated in intersections of the first electrodes and the second electrodes so as to output sensing signals; and an operation unit determining whether a touch has occurred based on the sensing signals, wherein the driving circuit unit generates the driving signals according to a matrix of N by N, wherein the matrix is created by inverting an element in a first column of a first row, elements in a second to (1+((N−4)/2)) th rows of the first column, and elements in the second to Nth columns of the second to Nth rows of a Hadamard matrix of N by N.

According to another aspect of the present disclosure, a method for sensing a touch input may include: applying driving signals to N first electrodes among a plurality of first electrodes, where N is a natural number equal to or greater than two; obtaining sensing signals from second electrodes intersecting the first electrodes; and determining whether a touch has occurred by calculating a correlation value between the sensing signals and the driving signals, wherein the applying of the driving signals includes applying the driving signals generated according to a matrix of N by N to the N first electrodes, the matrix is created by inverting an element in a first column of a first row, elements in a second to (1+((N−4)/2))th rows of the first column, and elements in the second to Nth columns of the second to Nth rows of a Hadamard matrix of N by N.

According to another aspect of the present disclosure, a method for generating driving signals to be applied to a plurality of driving electrodes of a touchscreen device may include: creating a Hadamard matrix of N by N, where N is a natural number equal to or greater than two; creating a first matrix by inverting elements in second to Nth columns of second to Nth rows of the Hadamard matrix; creating a second matrix by inverting an element in a first column of a first row of the first matrix; creating a third matrix by inverting elements in the second to the (1+((N−4)/2))th rows of the first column of the second matrix; and generating driving signals according to the third matrix.

The creating of the second matrix may include eliminating the first row of the first matrix to create the second matrix, and the creating of the third matrix may include inverting elements in the first to (fix((T−1)/2)) rows of the first column of the second matrix, where T denotes a length of the rows of the third matrix, and fix(x) denotes a function that drops the part to the right of the decimal point of x.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view showing an appearance of an electronic device including a touchscreen device according to an exemplary embodiment of the present disclosure;

FIG. 2 is a view of a panel unit included in a touchscreen device according to an exemplary embodiment of the present disclosure;

FIG. 3 is a cross-sectional view of a panel unit included in a touchscreen device according to an exemplary embodiment of the present disclosure;

FIG. 4 is a diagram illustrating a touchscreen device according to an exemplary embodiment of the present disclosure;

FIG. 5 is a view schematically illustrating a touchscreen device according to the exemplary embodiment in FIG. 4;

FIG. 6 is a matrix for illustrating driving signals according to an exemplary embodiment of the present disclosure;

FIGS. 7 through 11 are diagrams for illustrating a way to create the matrix shown in FIGS. 6; and

FIGS. 12 through 14 are diagrams for illustrating a way to create a matrix according to another exemplary embodiment of the present disclosure.

### DETAILED DESCRIPTION

Exemplary embodiments of the present disclosure will now be described in detail with reference to the accompanying drawings.

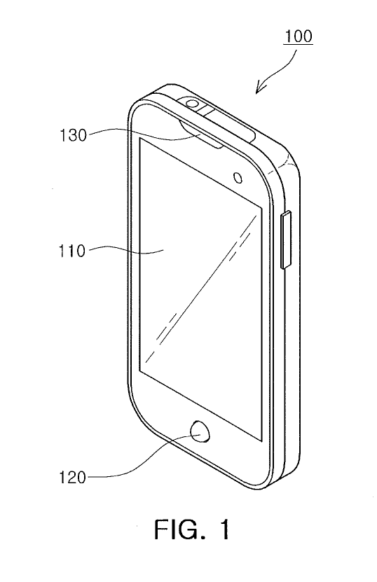

FIG. 1 is a perspective view showing an appearance of an electronic device including a touchscreen device according to an exemplary embodiment of the present disclosure.

Referring to FIG. 1, the electronic device 100 according to the present embodiment may include a display device 110 outputting images on a screen, an input unit 120, an audio unit 130 outputting sound, and a touch sensing device integrated with the display device 110.

As shown in FIG. 1, typically in mobile devices, the touch sensing device is integrated with the display device, and should have so high light transmissivity that the images on the display can be seen through. Therefore, the touch sensing device may be implemented by forming a sensing electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephthalate (PET), polycarbonate (PC), polyethersulf one (PES), polyimide (PI), polymethylmethacrylate (PMMA), or the like. In addition, the sensing electrode may be implemented as a fine conductor line formed of one of Ag, Al, Cr, Ni, Mo and Cu or an alloy thereof.

The display device may include a wiring pattern disposed at a bezel region thereof, in which the wiring pattern is connected to the sensing electrode formed of the transparent and conductive material. Since the wiring pattern is hidden by the bezel region, it may be formed of a metal material such as silver (Ag) and copper (Cu).

Since it is assumed that the touch sensing device according to the exemplary embodiment of the present disclosure is operated in a capacitive manner, the touchscreen device may include a plurality of electrodes having a predetermined pattern. Further, the touchscreen device may include a capacitance sensing circuit to sense a change in the capacitance generated in the plurality of electrodes, an analog-digital converting circuit to convert an output signal from the capacitance sensing circuit into a digital value, and a calculating circuit to determine if a touch has occurred based on the converted data of the digital value.

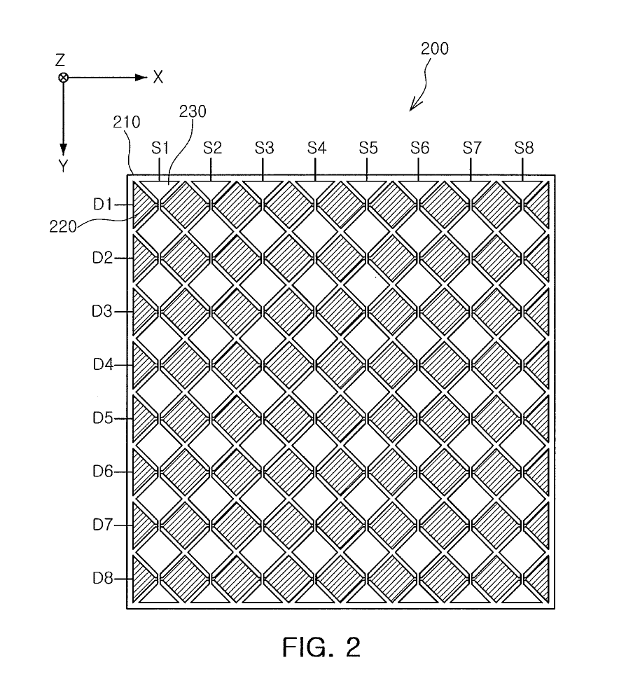

FIG. 2 is a view of a panel unit included in a touchscreen device according to an exemplary embodiment of the present disclosure.

Referring to FIG. 2, the panel unit 200 according to the exemplary embodiment includes a substrate 210 and a plurality of electrodes 220 and 230 provided on the substrate 210. Although not shown in FIG. 2, each of the plurality of electrodes 220 and 230 may be electrically connected to a wiring pattern on a circuit board attached to one end of the substrate 210 through a wiring and a bonding pad. The circuit board may have a controller integrated circuit mounted thereon so as to detect sensing signals generated in the plurality of electrodes 220 and 230 and may determine whether a touch has occurred based on the detected sensing signals.

The plurality of electrodes 220 and 230 may be formed on one surface or both surfaces of the substrate 210. Although the plurality of electrodes 220 and 230 are shown to have a lozenge- or diamond-shaped pattern in FIG. 2, it is apparent that the plurality of electrodes 220 and 230 may have a variety of polygonal shapes such as rectangle and triangle.

The plurality of electrodes 220 and 230 may include first electrodes 220 extending in the x-axis direction, and second electrodes 230 extending in the y-axis direction. The first electrodes 220 and the second electrodes 230 may be provided on both surfaces of the substrate 210 or may be provided on different substrates 210 such that they may intersect with each other. If all of the first electrodes 220 and the second electrodes 230 are provided on one surface of the substrate 210, an insulating layer may be partially formed at intersection points between the first electrodes 220 and the second electrodes 230.

On the regions in which wiring connecting to the plurality of electrodes 220 and 230 is provided other than the region in which the plurality of electrodes 220 and 230 is formed, a printed region may be formed on the region of the substrate 210 so as to hide the wiring typically formed of an opaque metal material.

A device, which is electrically connected to the plurality of electrodes 220 and 230 to sense a touch input, detects a change in capacitance generated in the plurality of electrodes 220 and 230 by a touch input to sense the touch input based on the detected change in capacitance. The first electrodes 220 may be connected to channels defined as D1 to D8 in the controller integrated circuit to receive predetermined driving signals, and the second electrodes 230 may be connected to channels defined as S₁ to S₈ to be used by the touch sensing device to detect a sensing signal. The controller integrated circuit may detect a change in mutual-capacitance generated between the first electrodes 220 and the second electrodes 230 as the sensing signal.

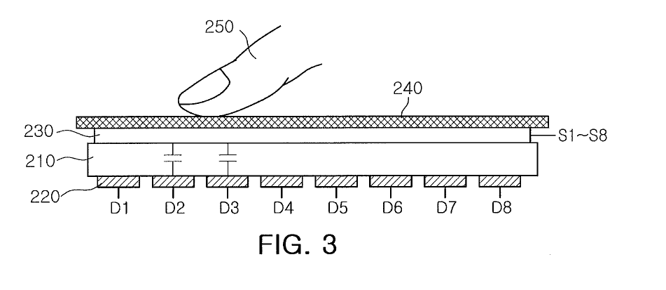

FIG. 3 is a cross-sectional view of a panel unit included in a touchscreen device according to an exemplary embodiment of the present disclosure; FIG. 3 is a cross-sectional view of the panel unit 200 illustrated in FIG. 2 taken in the y-z plane, in which the panel unit 200 may further include a cover lens 240 that is touched, in addition to the substrate 210 and the plurality of sensing electrodes 220 and 230 described above. The cover lens 240 is provided on the second electrodes 230 used in detecting sensing signals, to receive a touch input from a touching object 250 such as a finger.

When driving signals are applied to the first electrodes 220 through the channels D1 to D8, mutual-capacitance is generated between the first electrodes 220, to which the driving signals are applied, and the second electrodes 230. When the driving signals are applied to the first electrodes 220, a change in the mutual-capacitance is made between the first electrode 220 and the second electrode 230 close to the area with which the touching object 250 comes in contact. The change in the mutual-capacitance may be proportional to the overlapped area between the region that the touching object 250 comes into contact, and the region that the first electrodes 220, to which the driving signals are applied, and the second electrodes 230 form. In FIG. 3, the mutual-capacitance generated between the first electrodes 220 connected to channel D2 and D3, respectively, and the second electrodes 230 is influenced by the touching object 250.

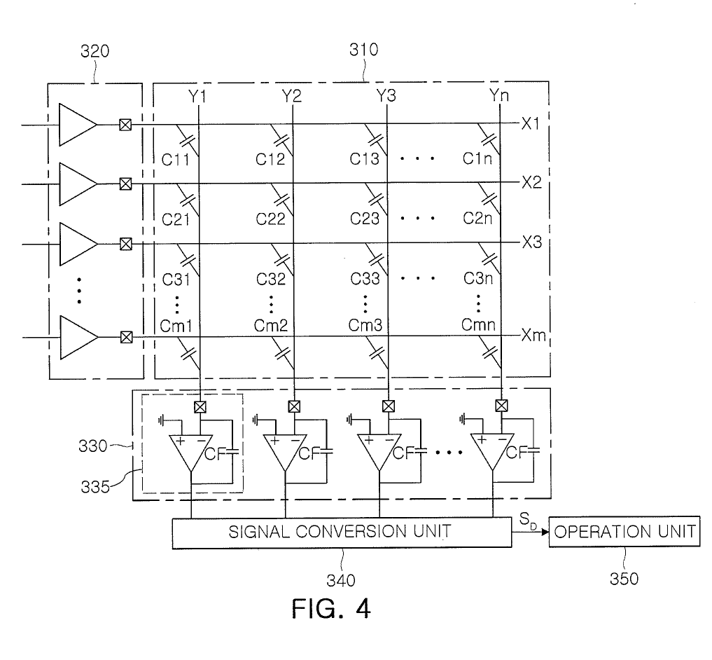

FIG. 4 is a diagram illustrating a touchscreen device according to an exemplary embodiment of the present disclosure.

Referring to FIG. 4, the touchscreen device according to the exemplary embodiment may include a panel unit 310, a driving circuit unit 320, a sensing circuit unit 330, a signal conversion unit 340, and an operation unit 350. The driving circuit unit 320, the sensing circuit unit 330, the signal conversion unit 340, and the operation unit 350 may be implemented as a single integrated circuit (IC).

The panel unit 310 may include rows of first electrodes (driving electrodes) X1 to Xm extending in a first axis direction (that is, the horizontal direction of FIG. 4), and columns of second electrodes (sensing electrodes) Y1 to Yn extending in a second axis direction (that is, the vertical direction of FIG. 4) crossing the first axis direction. Node capacitors C11 to Cmn are the equivalent representation of mutual capacitance generated in intersections of the first electrodes X1 to Xm and the second electrodes Y1 to Yn.

The driving circuit unit 320 may apply predetermined driving signals to the first electrodes X1 to Xm of the panel unit 310. The driving signals maybe square wave signals, sine wave signals, triangle wave signals, or the like, having specific frequency and amplitude. The driving circuit unit 320 includes a plurality of driving signal generation circuits so as to simultaneously apply driving signals to the first electrodes X1 to Xm. Further, the first electrodes X1 to Xm may be grouped so that the driving signals maybe applied thereto sequentially.

The sensing circuit unit 330 may detect capacitance of the node capacitors C11 to Cmn from the second electrodes Y1 to Yn so as to output sensing signals S_{A}. The sensing circuit unit 330 may include a plurality of C-V converters 335, each of which has at least one operational amplifier and at least one capacitor and is connected to the respective second electrodes Y1 to Yn.

The C-V converters 335 may convert the capacitance of the node capacitors C11 to Cmn into voltage signals so as to output sensing signals in an analog form. For example, each of the C-V converters 335 may include an integration circuit to integrate capacitance values. The integration circuit may integrate and convert capacitance values into a voltage value to output it.

Although the C-V converter 335 shown in FIG. 4 has the configuration in which a capacitor CF is disposed between the inverting input terminal and the output terminal of an operational amplifier, it is apparent that the circuit configuration may be altered. Moreover, each of the C-V converters 335 shown in FIG. 4 has one operational amplifier and one capacitor. It may have a number of operational amplifiers and capacitors.

When driving signals are applied to the first electrodes X1 to Xm, capacitance may be simultaneously detected from the second electrodes, the number of required C-V converts 335 is equal to the number of the second electrodes Y1 to Yn, i.e., n.

The signal conversion unit 340 may generate a digital signal S_{D} from the sensing signals output from the sensing circuit unit 330. For example, the signal conversion unit 340 may include a time-to-digital converter (TDC) circuit measuring a time in which the analog signals in the form of voltage output from the sensing circuit unit 330 reach a predetermined reference voltage level to convert the measured time into the digital signal S_{D}, or an analog-to-digital converter (ADC) circuit measuring an amount by which a level of the analog signals output from the sensing circuit unit 330 is changed for a predetermined time to convert the changed amount into the digital signal S_{D}.

The operation unit 350 may determine whether a touch has occurred on the panel unit 310 based on the digital signal S_{D}. The operation unit 350 may determine the number of touch inputs, coordinates of the touch inputs, and the type of gesture of the touch inputs or the like made on the panel unit 310, based on the digital signal S_{D}.

The digital signal S_{D}, which is used by the operation unit 350 to determine whether a touch has occurred, may be data that is a numerical value representing a change in capacitance of the capacitors C11 to Cmn, especially representing a difference between the capacitance with and without a touch input. Typically in a capacitive type touchscreen device, a region touched by a conductive object has less capacitance than other regions not touched.

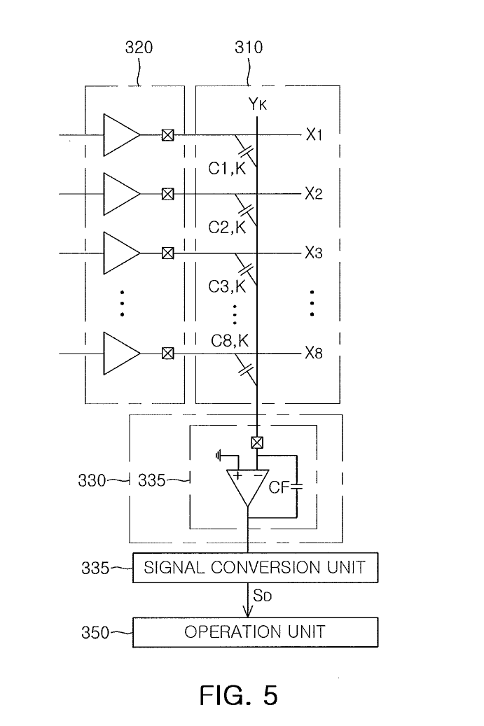

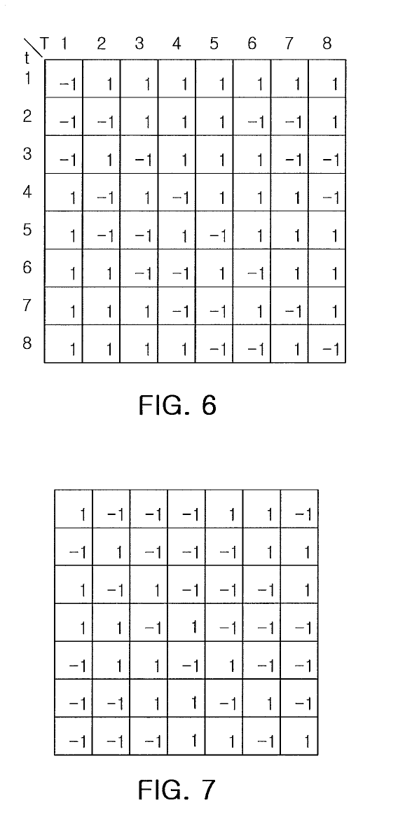

FIG. 5 is a diagram schematically showing the touchscreen device according to the exemplary embodiment shown in FIG. 4, and FIG. 6 is a matrix for illustrating driving signals according to an exemplary embodiment of the present disclosure. Hereinafter, the touchscreen device according to the exemplary embodiment will be described in detail with reference to FIGS . 4 through 6.

The driving circuit unit 320 may apply voltage VDD for elements indicated by “1” and may apply voltage −VDD for elements indicated by “−1” among the elements in the matrix of 8 by 8 shown in FIG. 6. Alternatively, the driving circuit unit 320 may apply a voltage for the elements indicated by 1 and a voltage having the phase difference of 180 degrees for those indicated by −1, respectively.

The driving signals associated with the elements in the matrix of 8 by 8 shown in FIG. 6 may be simultaneously applied at each of timings T1 to T8. The driving circuit unit 320 may apply the driving signals repeatedly with the timings T1 to T8 as a single period. The driving signals generated in association with the elements in the first to eighth rows may be applied to the first electrodes X1 to X8, respectively, and the driving signals generated in association with the elements in the first to eighth columns may be simultaneously applied to the first electrodes X1 to X8 at each of timings T1 to T8.

In the above-description, it is assumed that there are eight first electrodes Xt on the panel unit 310, where t is 1 to 8, and the driving circuit unit 320 simultaneously applies the driving signals to all of the first electrodes X1 to X8. When there is a plurality of first electrodes, for example, 80 first electrodes, it may be also possible to group the 80 first electrodes into ten groups in each of which eight first electrodes exist, so that the driving circuit unit 320 may apply the driving signals sequentially group by group.

FIGS. 7 through 11 are diagrams for illustrating a way to create the matrix shown in FIG. 6. Referring to FIG. 7, the elements in the first row represent an example of a maximum length sequence which is well known, and the elements in the second to seventh rows are created by shifting the elements in the first row by one bit sequentially. The elements in the first to eighth rows represent examples of various maximum length sequences, and it is apparent that the elements in the first to eighth rows maybe changed according to examples of various maximum length sequences.

Furthermore, although the elements in the rows are shifted to the direction in which the order of the columns ascends as the order of the rows increases in FIG. 7, the elements in the rows may also be shifted to the direction in which the order of columns descend as the order of rows increases. Further, although the length of the maximum length sequence is 7 in FIG. 7, it is apparent that the code length of the maximum length sequence may be changed.

Now, referring to FIG, 8, it can be seen that a first row and a first column are newly added, in which all of the elements are 1 s. When driving signals are applied according to the matrix shown in FIG. 8, there is a problem, as discussed next, in that the sum of driving signals applied at the first timing, i.e., the sum of elements in the first column is quiet different from the sum of driving signals applied at different timings, i.e., the sums of elements in the second to eighth columns. The same problem may be found in a Hadamard matrix created according to a Walsh code.

In order to detect capacitance generated at the first timing, the sensing circuit unit 330 needs to have large capacitors and the signal conversion unit 340 needs to have a high resolution analog-to-digital converter, and therefore manufacturing cost increases and the volume of the device becomes larger.

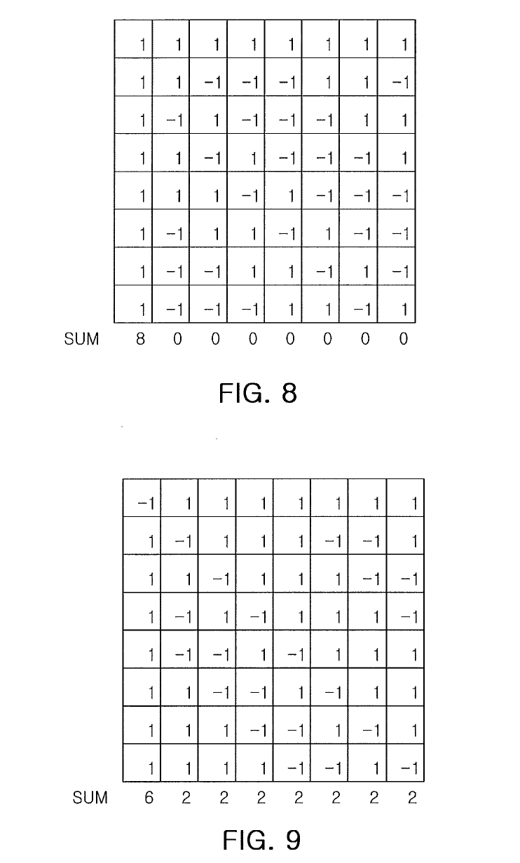

In order to solve such problems, referring to FIG. 9, the maximum length sequence elements in FIG. 8, i.e., the elements in the second to eighth columns of the second to eighth rows and the element in the first column of the first row are inverted.

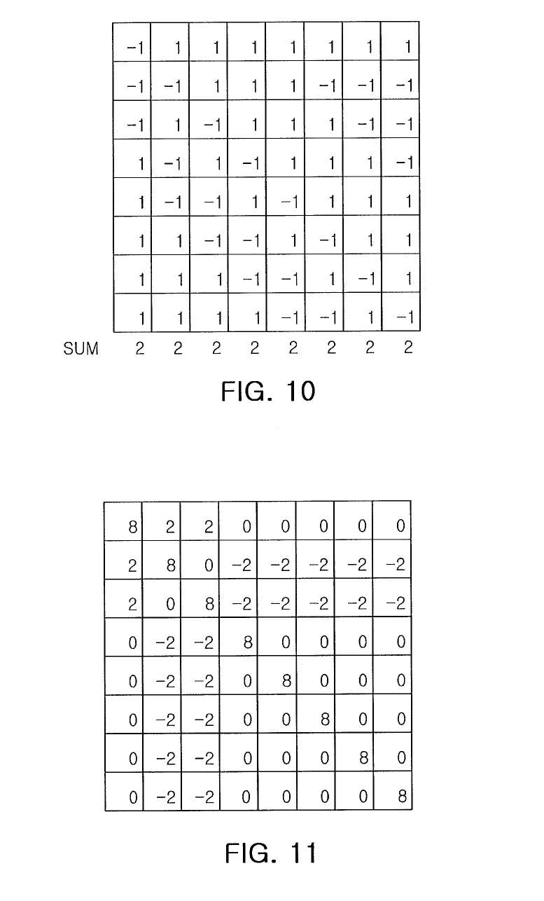

Subsequently, elements in L rows next to the first column of the first row are inverted, where L=(N−4)/2 and N denotes the number of elements in one row or column of the matrix, i.e., a code length. For example, since the length of the matrix in FIG. 9 is 8, elements in two rows next to the first row of the first column are inverted so as to create the matrix shown in FIG. 10, i.e., the matrix shown in FIG.6. The sums of elements in each of the columns in FIG. 10 are two, and thus the above problem has been solved.

Although some elements shown in FIG. 8 are inverted to create the matrix shown in FIG. 10, exemplary embodiments of the present disclosure are not limited thereto but the matrix shown in FIG. 10 may be replaced with a matrix that is created by inverting some elements in a Hadamard matrix created according to a Walsh code in the above-described manner.

When the driving circuit unit 320 applies driving signals to a plurality of first electrodes according to the matrix shown in FIG. 6, the sensing circuit unit 330 detects capacitance generated in intersections of the first electrodes X1 to X8 and the second electrodes Yk from the second electrodes Yk so as to output sensing signals Sk, which may be expressed as Mathematical Expression 1 below: Where the term C_{t,k} denotes mutual-capacitance generated at the intersections of the first electrodes Xt and the second electrodes Yk. The term Dt denotes driving signals applied to the first electrodes Xt.

Sk=Σₜ₋₁⁸Ct,k*Dt [Mathematical Expression 1]

Assuming that there are m first electrodes, Mathematical Expression 1 may be expanded as Mathematical Expression 2 below:

Sk=Σₜ₌₁^{m}Ct,k*Dt [Mathematical Expresion 2]

Then, the operation unit 350 may determine whether a touch has occurred based on sensing signals Sk. The operation unit 350 may calculate a correlation value Corr_{t,k} by performing correlation operation between the sensing signals Sk and the driving signals. More specifically, the operation unit 350 may calculate the correlation value by performing correlation operation between the sensing signals Sk acquired for a single period and the driving signals acquired for a single period.

However, the driving signals applied according to the matrix shown in FIG. 6 are generated by modifying a maximum length sequence such that elements in rows are not completely orthogonal. Therefore, a cross correlation value exists within the calculated correlation value, and thus a touch input cannot be accurately determined.

FIG. 11 is correlation data of the correlation values created when the two matrices shown in FIG. 6 are correlated. Referring to FIG. 11, it can be seen that elements indicated by “2” or “−2,” i.e., cross correlation values are created as well as the elements indicated by 8, i.e., auto correlation values. It can be seen that the cross correlation values are created since the elements in the rows are not completely orthogonal.

According to the exemplary embodiment, the operation unit 350 may combine the correlation values calculated at each of the timings so as to determine whether a touch has occurred, independently of the cross correlation values.

Assuming that capacitance values at intersections of the first electrodes X1 to X8 and the second electrodes Yk are referred to a₁ to a₈ and that the correlation values created at each of the first to eighth timings are referred to as S₁ to S₈, the correlation values S₁ to S₈ shown in FIG. 11 maybe expressed as Mathematical Expression 3 below:

[Mathematical Expression 3]

s₁=8a₁+2a₂+2a₃ (1)

s₂=2a₁+8a₂−2a₄−2a₅−2a₆−2a₇−2a₈ (2)

s₃=2a₁+8a₃−2a₄−2a₅−2a₆−2a₇−2a₈ (3)

s₄=−2a₂−2a₃+8a₄ (4)

s₅=−2a₂−2a₃+8a₅ (5)

s₆=−2a₂−2a₃+8a₆ (6)

s₇=−2a₂−2a₃+8a₇ (7)

s₈=−2a₂−2a₃+8a₈ (8)

By substituting the sum of a₂ to a_{L+1} with K₁, the sum of a_{L+2} to a_{N} with K₂, the sum of S₂ to S_{L+1} with TS₁, the sum of S_{L+2} to S_{N} with TS₂, Equation (1) in Mathematical Expression 3 may be expressed as Equation (9) in Mathematical Expression 4, the sum of Equations (2) and (3) in Mathematical Expression 3 may be expressed as Equation (10) in Mathematical Expression 4, the sums of Equations (4) to (8) in Mathematical Expression 3 maybe expression as Equation (11) in Mathematical Expression 4.

[Mathematical Expression 4]

s₁=8a₁+2K₁ (9)

TS₁=4a₁+8K₁−4K₂ (10)

TS₂=−10K₁+8K₂ (11)

Since S₁, TS₁ and TS₂ are data values obtained by the operation unit 350, a₁, K₁ and K₂ may be calculated by solving Equations (9) to (11). In addition, by subtracting Equation (3) from Equation (2), the value of a₂−a₃ may be calculated, and by combining it into K₁=a₂+a₃, the values of a₂ and a₃ may be calculated. Moreover, the operation unit 350 may calculate the values of a₄ to a₈ in a similar manner and may use the calculated values of a₁ to a₈ to accurately determine whether a touch has occurred based on the cross correlation values.

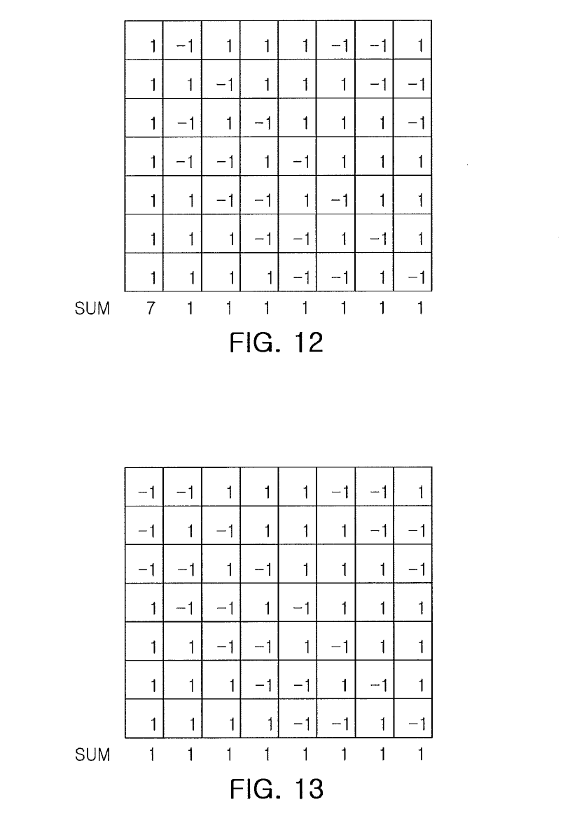

FIGS. 12 through 14 are diagrams for illustrating away to create a matrix according to another exemplary embodiment of the present disclosure.

The matrix shown in FIG. 12 is created by modifying the matrix shown in FIG. 9, specifically by eliminating the first row of the matrix shown in FIG. 9. Then, elements in the first column of the first to the Lth rows are inverted, where the number of elements in one row of the matrix, a code length is N. The symbol L is defined as fix((T−1)/2), where the symbol fix(x) refers to a function that drops the part to the right of the decimal point of x, an integer T denotes the number of elements in one row, i.e., the length of a row. For example, since the length of the row is 8 in FIG. 12, if the elements in the first column of the first to third rows are inverted, the matrix shown in FIG. 13 may be created. The driving circuit unit 310 may create driving signals according to the matrix shown in FIG. 13.

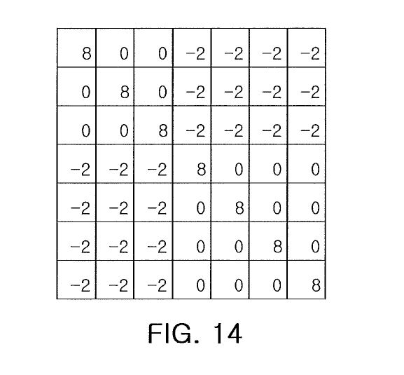

FIG. 14 is correlation data of the correlation values created when the two matrices shown in FIG. 13 are correlated. Similarly to FIG. 11, it can be seen that elements indicated by “1,” i.e., cross correlation values are created as well as the elements indicated by 8, i.e., auto correlation values. The cross correlation values are created since the elements in the rows are not completely orthogonal.

By applying the correlation values shown in FIG. 14 in a manner similar to derive Mathematical Expression 5, Mathematical Expression 4 may be simplified as Mathematical Expression 5. The operation unit 350 may calculate the values of a₁ to a₈ according to Mathematical Expression 6 to determine whether a touch has occurred.

[Mathematical Expression 5]

TS₁=8K₁−6K₂ (12)

TS₂=−8K₁+8K₂ *(13)

As set forth above, according to exemplary embodiments of the present disclosure, driving signals are simultaneously applied to a plurality of driving electrodes, so that a touch response speed can be improved.

Further, according to exemplary embodiments of the present disclosure, the sum of driving signals applied at each of timings is kept constant so that manufacturing cost can be saved and the volume can be reduced.

While exemplary embodiments have been shown and described above, it will be apparent to those skilled in the art that modifications and variations could be made without departing from the spirit and scope of the present disclosure as defined by the appended claims.

What is claimed is:

1. A touchscreen device, comprising:
a panel unit including a plurality of first electrodes and a plurality of second electrodes;
a driving circuit unit simultaneously applying driving signals to N first electrodes among the first electrodes, where N is a natural number equal to or greater than two;
a sensing circuit unit detecting capacitance generated in intersections of the first electrodes and the second electrodes so as to output sensing signals; and
an operation unit determining whether a touch has occurred based on the sensing signals,
wherein the driving circuit unit generates the driving signals according to a matrix of N by N, wherein an element in a first column of a first row is −1, elements in second to Nth columns of the first row are 1 s, elements in second to (1+((N−4)/2))th rows of the first column are −1 s, elements in (2+((N−4)/2))th to the Nth rows of the first column are 1 s, and elements in the second to Nth columns of the second to Nth rows are created according to a maximum length sequence.

2. The touchscreen device of claim 1, wherein elements in the second to Nth columns of the second row of the matrix are created by inverting codes according to the maximum length sequence, and elements in the second to Nth columns of the third to Nth rows of the matrix are created by shifting elements in the second to Nth columns of the second row of the matrix by one bit for every row.

3. The touchscreen device of claim 1, wherein the driving circuit unit simultaneously applies driving signals generated according to N rows of the matrix to the N first electrodes.

4. The touchscreen device of claim 1, wherein the driving circuit unit applies driving signals generated according to N columns of the matrix at respective N timings.

5. The touchscreen device of claim 1, wherein the sensing circuit unit detects capacitance and outputs the sensing signals using
Sk=Σₜ₌₁^{m}Ct,k*Dt
where Sk denotes a sensing signal, Ct,k denotes capacitance generated in intersections of first electrode Xt and second electrode Yk, and Dt denotes driving signal applied to first electrode Xt.

6. The touchscreen device of claim 1, wherein the operation unit determines whether a touch has occurred based on a correlation value during a single period calculated by performing a correlation operation between the sensing signals acquired during a single period of the driving signals and the matrix.

7. A method for sensing a touch input, the method comprising:
applying driving signals to N first electrodes among a plurality of first electrodes, where N is a natural number equal to or greater than two;
obtaining sensing signals from second electrodes intersecting the first electrodes; and
determining whether a touch has occurred by calculating a correlation value between the sensing signals and the driving signals,
wherein the applying of the driving signals includes applying the driving signals generated according to a matrix of N by N to the N first electrodes, wherein an element in a first column of a first row is −1, elements in second to Nth columns of the first row are 1 s, elements in second to (1+((N−4)/2))th rows of the first column are −1 s, elements in (2+((N−4)/2))th to the Nth rows of the first column are 1 s, and elements in the second to Nth columns of the second to Nth rows are created according to a maximum length sequence.

8. The method of claim 7, wherein, in the applying of the driving signals, elements in the second to Nth columns of the second row of the matrix are created by inverting codes according to the maximum length sequence, and elements in the second to Nth columns of the third to Nth rows of the matrix are created by shifting elements in the second to Nth columns of the second row of the matrix by one bit for every row.

9. The method of claim 7, wherein the applying of the driving signals includes simultaneously applying driving signals generated according to N rows of the matrix to the N first electrodes.

10. The method of claim 7, wherein the applying of the driving signals includes applying driving signals generated according to N columns of the matrix at respective N timings.

11. The method of claim 7, wherein the determining whether a touch has occurred includes determining whether a touch has occurred based on a correlation value calculated by performing a correlation operation between the sensing signals acquired during a single period of the driving signals and the matrix.

12. A method of generating driving signals to be applied to a plurality of driving electrodes of a touchscreen device, the method comprising:
creating a first matrix of (N−1) by (N−1) by determining elements in a first row according to a maximum length sequence and determining elements in the rest rows by shifting the elements in the first row by one bit, where N is a natural number equal to or greater than two;
creating a second matrix of N by N by adding a first row and a first column having elements of all is to the first matrix;
creating a third matrix by inverting an element in the first column of the first row of the second matrix and elements in the second to Nth columns of the second to Nth rows;
creating a fourth matrix by inverting elements in the second to the (1+((N−4)/2))th rows of the first column of the third matrix; and
generating driving signals according to the fourth matrix.

13. The method of claim 12, wherein the generating of the driving signals includes generating positive driving voltages for the elements indicated by 1 in the fourth matrix and negative driving voltages for the elements indicated by −1 in the third matrix.

14. The method of claim 12, wherein the generating of the driving signals includes generating the driving signals according to N rows of the fourth matrix, and the driving signals generated according to N rows of the fourth matrix are simultaneously applied to N driving electrodes of the plurality of driving electrodes.

15. The method of claim 12, wherein the generating of the driving signals includes generating the driving signals according to N columns of the fourth matrix, and the driving signals generated according to N columns of the fourth matrix are applied to the plurality of driving electrodes at respective N timings.

16. The method of claim 12, wherein the creating of the third matrix includes inverting elements in the second to Nth columns of the second to Nth rows of the second matrix and eliminating the first row to create the third matrix; and wherein the creating of the fourth matrix includes inverting elements in the first to (fix((T−1)/2)) rows of the first column of the third matrix to create the fourth matrix, where T denotes a length of the rows of the third matrix, and fix(x) denotes a function that drops the part to the right of the decimal point of x.

17. A touchscreen device, comprising:
a panel unit including a plurality of first electrodes and a plurality of second electrodes;
a driving circuit unit simultaneously applying driving signals to N first electrodes among the first electrodes, where N is a natural number equal to or greater than two;
a sensing circuit unit detecting capacitance generated in intersections of the first electrodes and the second electrodes so as to output sensing signals; and
an operation unit determining whether a touch has occurred based on the sensing signals,
wherein the driving circuit unit generates the driving signals according to a matrix of N by N, wherein the matrix is created by inverting an element in a first column of a first row, elements in a second to (1+((N−4)/2))th rows of the first column, and elements in the second to Nth columns of the second to Nth rows of a Hadamard matrix of N by N.

18. A method for sensing a touch input, comprising:
applying driving signals to N first electrodes among a plurality of first electrodes, where N is a natural number equal to or greater than two;
obtaining sensing signals from second electrodes intersecting the first electrodes; and
determining whether a touch has occurred by calculating a correlation value between the sensing signals and the driving signals,
wherein the applying of the driving signals includes applying the driving signals generated according to a matrix of N by N to the N first electrodes, the matrix is created by inverting an element in a first column of a first row, elements in a second to (1+((N−4)/2))th rows of the first column, and elements in the second to Nth columns of the second to Nth rows of a Hadamard matrix of N by N.

19. A method for generating driving signals to be applied to a plurality of driving electrodes of a touchscreen device, the method comprising:
creating a Hadamard matrix of N by N, where Nis a natural number equal to or greater than two;
creating a first matrix by inverting elements in second to Nth columns of second to Nth rows of the Hadamard matrix;
creating a second matrix by inverting an element in a first column of a first row of the first matrix;
creating a third matrix by inverting elements in the second to the (1+((N−4)/2))th rows of the first column of the second matrix; and
generating driving signals according to the third matrix.

20. The method of claim 19, wherein the creating of the second matrix includes eliminating the first row of the first matrix to create the second matrix; and
wherein the creating of the third matrix includes inverting elements in the first to (fix((T−1)/2)) rows of the first column of the second matrix, where T denotes a length of the rows of the third matrix, and fix(x) denotes a function that drops the part to the right of the decimal point of x.
